(19) United States
(12) Patent Application Publication
(10) Pub. No.: US 2018/0176994 A1
(43) Pub. Date: Jun. 21, 2018

(54) HEATING DEVICE, COOKING APPLIANCE WITH A HEATING DEVICE, AND METHOD FOR PRODUCING A HEATING ELEMENT

(71) Applicant: E.G.O. Elektro-Geraetebau GmbH, Oberderdingen (DE)

(72) Inventor: Wolfgang Wittenhagen, Bretten (DE)

(21) Appl. No.: 15/845,044

(22) Filed: Dec. 18, 2017

(30) Foreign Application Priority Data
Dec. 19, 2016 (DE) 10 2016 225 462.6

(51) Int. Cl. H05B 3/74; F24C 7/06; F24C 15/10

(52) U.S. Cl. CPC H05B 3/748; H05B 1/0266; F24C 15/102; F24C 7/065

(57) ABSTRACT

A heating device has a sheet-like heating element and a holding device for the heating element, wherein the heating element is held along an outer edge on the holding device and, by way of at least 70% of its surface area, runs freely within the holding device. The heating element has a weave which at least partially contains heating conductor material. Therefore, warp threads can advantageously be composed of electrically conductive heating conductor material, and weft threads can be composed of carbon fibre or ceramic fibres. The heating element can be centrally supported or be provided with a structuring over its surface area, which structuring stabilizes the heating element, for example can be corrugated.

### CROSS-REFERENCE TO RELATED APPLICATIONS

This application claims priority to German Application No. 10 2016 225 462.6, filed Dec. 19, 2016, the contents of which are hereby incorporated herein in its entirety by reference.

### TECHNOLOGICAL FIELD

The invention relates to a heating device with a sheet-like heating element and a holding device for this heating element. The invention further relates to a cooking appliance with a heating device of this kind, and also to a method for producing a heating element of this kind, in particular for a heating device of this kind.

### BACKGROUND

U.S. Pat. No. 6,207,935 B1 discloses a heating device of this kind and also a hob which is provided with the heating device, wherein a heating element for the hob is cut out of metal foil in a geometric pattern. Therefore, a certain heating conductor length of individual heating conductors can be achieved. Furthermore, a large emission area of the heating element upwards in the direction of a hob plate and a cooking vessel positioned on the hob plate can be achieved.

### BRIEF SUMMARY

The invention is based on the problem of providing a heating device of the kind mentioned in the introductory part, a cooking appliance of the kind mentioned in the introductory part and also a method for producing a heating element, with which problems with the prior art can be solved and it is possible, in particular, to produce and to install heating elements for advantageously usable heating devices in a reliable and cost-effective manner.

This problem is solved by a heating device, cooking appliances, and also by a method for producing a heating element. Advantageous and preferred refinements of the invention are the subject matter of the further claims and will be explained in more detail below. In the process, some of the features will be described only for the heating device, only for a cooking appliance or only for a method for producing a heating element. However, irrespective of this, the features are intended to be able to apply both to a heating device and to a cooking appliance and also to a method for producing a heating element on their own and independently of one another. The wording of the claims is incorporated in the description by express reference.

It is provided that the heating device has a sheet-like heating element and a holding device for the heating element. In this case, the heating element is held along an outer edge or its outer edge on the holding device. The heating element, by way of at least 70% of its surface area, runs freely between the holding device or within the holding device, advantageously by way of at least 85%. This means that holding devices or other holding means do not engage with or support a top side or a bottom side of the heating element in this surface area portion. As a result, very good emission of the heating power of the heating element over the surface area is possible.

According to the invention, the heating element has a lattice or a weave which is at least partially composed of heating conductor material or contains heating conductor material. A lattice or weave of this kind can advantageously be composed of thin heating element sections, for example of wires or threads, with intermediate areas or free areas therebetween. The heating element sections, for their part, can themselves be composed of heating conductor material or can be at least partially coated with a heating conductor material of this kind, for example only on a side which faces in one direction. As an alternative, the heating element sections can also be coated or sheathed with heating conductor material all the way around or completely. Owing to the design as a lattice or weave, a heating element of this kind can have a large number of intermediate areas between the heating element sections or between the wires or threads.

In the case of a lattice, the intermediate areas can advantageously have a larger surface area proportion of the entire heating element than its heating element sections or wires. A lattice of this kind can also be stamped or etched out of a sheet-like material, so that a lattice shape remains as it were. In this case, the total surface area of the intermediate areas is greater than the total surface area of the wires or threads. The total surface area of the intermediate areas is advantageously 35% to 90% of the total surface area of the heating element, particularly advantageously 60% to 80%.

In the case of a heating element in the form of a weave which can be woven either from wires or from threads or from a mixture thereof, the intermediate areas can be relatively small. The total surface area of the intermediate areas or of the free areas is therefore smaller than the total surface area of the wires or threads. The total surface area of the intermediate areas is advantageously 5% to 40% of the total surface area of the heating element, particularly preferably 10% to 30%.

In an advantageous refinement of the invention, the heating element is held at least at several holding points of the holding device. Holding points of this kind can advantageously run along a holding line; in particular, the holding points are provided continuously as a holding line or a plurality of holding lines.

In one refinement of the invention, it is possible that a sheet-like reflector for the heating element is provided in a direction away from a heating direction of the heating element, for example in the direction towards a hob plate of a hob, advantageously on a bottom side of the heating device. A reflector of this kind can particularly advantageously be held on the holding device beneath the heating element. The reflector can be of metallic design, for example as a polished metal surface or the like, in order to reflect the downwardly emitted heating energy upwards in the heating direction or in the direction of an abovementioned hob plate as well as possible. The reflector can be flat, curved or structured.

In an advantageous refinement of the invention, the holding device is formed in a circumferential or closed manner. This can be a kind of ring, advantageously with the abovementioned holding line or the number of holding points for the heating element on it, the holding line or number of holding points corresponding to its outer contour. In principle, the shape of the heating device can be any desired shape, for example can even be round. However, it is advantageously rectangular or at least in the form of a parallelogram. As a result, a largely constant current flow and therefore a largely, advantageously completely, uniform power density can be achieved within the sheet-like heating element. Therefore, a current can flow, for example, from one side of the parallelogram to the opposite side.

The holding device advantageously bounds a lateral extent of the heating device. The heating element is arranged within the lateral extent and has a course there in the manner of an area, advantageously in a closed manner. This means that the heating element runs only within the holding device. Therefore, the holding device can advantageously simultaneously also form a thermal insulation, as is known per se from radiant heating devices and also from U.S. Pat. No. 6,207,935 B1 which was mentioned at the outset.

An arrangement for making electrical contact with the heating element can also run along the holding device or at least along the holding device or be integrated therein. To this end, the heating element can have two connection contact-making arrangements on opposite outer sides or outer edges. It goes without saying that this is once again particularly straightforward and easy to carry out in the case of a heating element of rectangular shape. The connection contact-making arrangements can be designed as contact strips, for example as thin metal strips. The contact strips can be attached to outer edges and, in the process, also establish an electrical contact-making connection to the heating conductor material. The contact strips can be folded around the outer edges for fastening purposes and therefore enclose the outer edges between them or can be welded to edge strips along the outer sides, advantageously both.

In a further refinement of the invention, it is possible that a central holder is provided in a central region of the heating device or the heating element, in particular at a centre point, for holding purposes in this central region. Therefore, excessive sagging of a heating element which is not inherently stable can be prevented in the central region. As an alternative to a holding arrangement at substantially one point, a linear holding arrangement can also be provided at a central holder of this kind. The linear holding arrangement runs along a central straight line, particularly in the case of a rectangular or parallelogram-shaped heating element, so that the sheet-like heating element is uniformly held or supported. A central holder of this kind can be connected to the other heating device, for example to its lower end. Therefore, a kind of common substrate can be provided.

In a further refinement of the heating device, mechanical stabilization of the heating element can be created by the heating element being three-dimensionally structured or deformed perpendicular or perpendicular and parallel to the opposite outer edges or contact strips. The heating element can acquire, for example, a corrugated, sinusoidal or sawtooth-like structure. As an alternative, the heating element can have trench-like or crater-like stabilizing embossed portions which are not directed or do not have an orientation, as mentioned above. Corresponding measures for stabilizing free areas are known from metal sheet or the like.

In an advantageous refinement of the invention, the holding device, particularly advantageously also an above-described central holder, is arranged on a thermally insulating substrate. Therefore, a structure similar to U.S. Pat. No. 6,207,935 B1 which was mentioned at the outset or some other customary radiant heating body, in which a strip-like elongate heating element is partially inserted directly into a thermally insulating substrate of this kind, can be realized in principle.

If the heating element has an abovementioned form of a lattice or a weave, it can advantageously consist of elongate heating element sections which intersect or are combined in different directions. A weave of this kind consists of warp threads and weft threads in a customary manner. In this case, advantageously only one of the two types of thread is electrically conductive for the heating element function or contains heating conductor material or is composed of heating conductor material. The other thread is then composed of an electrically insulating material and can primarily exert a mechanically supporting effect. Ceramic fibres, basalt fibres or carbon fibres are suitable for this purpose. The advantage when only one of the two threads is electrically conductive or exhibits the heating element function is that no electrical contact-making connection is made at the intersection points with the other threads, and primarily no current flow takes place either. This cannot be accurately predetermined in the case of an established contact-making connection of this kind and would sometimes also be problematic given surface oxidation. In addition, setting a specific distribution of the current density and thus also the power density is much simpler.

As an alternative to the abovementioned threads which advantageously each comprise a large number of fibres in straight or twisted form, so-called monofilaments or wires can also be used. Wires of this kind could also, at least for the heating element function, be composed of a suitable metal and be electrically conductive and also fulfil the heating element function. Metal alloys which are composed of, for example, nickel and chromium or iron, chromium and aluminium are suitable here.

In a further possible refinement of the invention, wires in one direction could also be combined with threads in the other direction. In this case, the wires can once again advantageously be composed of heating conductor material or contain a heating conductor material of this kind for the heating element function.

In a yet further refinement of the invention, a heating element can be in the form of a lattice and have lattice sections which run substantially at right angles. A lattice of this kind can, as it were, consist of intersecting heating element sections which, however, are produced in an integral manner, for example by being stamped out of a corresponding foil or a thin heating conductor material. A heating element of this kind can then be produced in an integral manner and in one piece.

The heating element can advantageously have heating element sections and apertures running therebetween as intermediate areas. The surface area portion of the apertures or intermediate areas is advantageously greater than the surface area proportion of the heating element sections, particularly advantageously by a factor of 2 to 20, in particular by a factor of 5 to 10. If a heating element is composed of an abovementioned weave, a considerably lower factor is advantageous, therefore the surface area proportion of the intermediate areas can be smaller than the surface area proportion of the heating element sections.

In a further refinement of the invention, the heating element, advantageously at electrically conductive heating element sections, can be at least partially coated with a catalytically active material. The entire heating element or some heating element sections or some of the individual threads or wires can also be completely composed of a catalytically active material of this kind. However, this makes no contribution in respect of efficiency since a catalyst acts on its surface anyway and it would also be very costly in view of the frequently very expensive materials. It is possible that not all of the parallel heating element sections or thread or wires which are situated next to one another are coated with a catalytically active material of this kind or contain the material, but rather only, for example, every second, every third or every fourth heating element section or thread or wire.

Owing to a catalyst effect of this kind directly on the heating element, advantageous applications of a heating device according to the invention can occur primarily where the heating element heats air directly and not only serves as a radiant heating arrangement. Air which is flowing past can be purified in this way.

A possible cooking appliance according to the invention can be a hob with a hob plate in one refinement of the invention. At least one above-described heating device, advantageously a plurality thereof, is arranged beneath the hob plate. In this case, a heating device of this kind can be used and also operated, in principle, as a radiant heating device which is known per se. In this case, the hob plate should be as transmissive to heat radiation as possible, for example also be composed of glass ceramic, as is generally customary. In one refinement of the invention, it is possible that the holding device presses the heating element as flat as possible against the bottom side of the hob plate which should then be electrically insulating and, for example, can likewise be composed of glass ceramic. The heating device or the heating element can then operate as a contact heating arrangement and be operated, for example, with a low voltage, that is to say a 50 V AC voltage or a 120 V DC voltage. In this case, the heating element is operated in a temperature region of a few 100° C., advantageously 200° C. to 500° C., but below the temperature of more than 1000° C. at which temperature radiant heating bodies usually operate.

An alternative cooking appliance according to the invention can be an oven with an oven muffle. At least one above-described heating device can be arranged on or in this oven muffle. According to one option, a heating device according to the invention can be arranged in the oven as a heating body providing heat from the bottom and to this end can be installed below a base of the oven muffle, as is known per se from the prior art. In this case, so-called tubular heating bodies are usually used in the prior art. A further option is the use in the oven muffle as a heating body providing heat from the top. A heating body of this kind providing heat from the top is usually installed on the bottom side of the ceiling of the oven muffle in a freely running manner and can also be operated as a grill since it burns at temperatures of above 700° C. and therefore generates radiant heat for grilling in the oven muffle. In this case, the heating device should likewise be suitable for operation as a grill.

The above-described option of additionally providing catalytically active material is particularly advantageous in the case of use in an oven. A heating element which is provided with the catalytically active material can then be provided on or in the oven muffle, so that it comes into contact with the air in the oven muffle and can catalytically purify the air by catalytic combustion of impurities or disturbing particles contained therein. Therefore, a heating element of this kind can be arranged, for example, on a fan of a hot-air oven where an annular tubular heating body is normally used in a hot-air oven.

An advantageous method for producing a heating element, as can be used primarily in a heating device according to the invention or an abovementioned cooking appliance, provides that a lattice or weave is generated, as has been described above. The lattice or weave has heating element sections and also a heating element function and is of sheet-like design. The lattice or weave can be woven as a weave with corresponding warp threads and weft threads or warp wires and weft wires. A material of this kind can either already be produced in strip form with a width as is also desired afterwards for the heating element or the heating device. As an alternative, the material can also be produced with a larger surface area and a strip can be cut out therefrom. As an alternative to production in this way, a corresponding lattice of a heating element can be stamped, etched or lasered out of heating conductor material.

In a following step, in each case one contact strip which is composed of electrically conductive strip material is applied to a strip of the desired width of the heating element in a continuous process on its two opposite outer edges. To this end, the outer edges of the strip of the heating element can be folded into these contact strips. Accordingly, electrically conductive strip material can also be, for example, a thin metal sheet which is composed of electrically conductive material.

In a further step, the contact strips can be mechanically and electrically connected to the strip comprising the lattice or the weave as composite. This is advantageously achieved by welding. This connection is particularly advantageously made in a continuous process, wherein both the strip of the heating element and also the strip material for the contact strips can be present in a long length and can be wound, for example, onto drums or the like and then be unwound from the drums or the like. Contact strips of this kind serve not only for making uniform and reliable electrical contact, but can also provide a certain degree of mechanical strength. However, this still does not necessarily replace the holding device mentioned at the outset, even if this were to be possible. As a result, handling of the heating element when assembling a heating device is also made easier.

A heating element in the form of a composite is then cut to a specific length from the elongate strips. This heating element is then also installed into a heating device in the above-described manner.

In a further refinement of the invention, it can be provided that solid or braided electrical connection lines are attached to a contact strip in each case. This is advantageously done by contact welding. Plug-in contacts can also possibly be directly fitted or welded on, in particular plug-in contact lugs. Therefore, electrical connection lines can be easily plug connected.

These and further features are apparent not only from the claims but also from the description and the drawings, where the individual features can in each case be realized on their own or jointly in the form of subcombinations in an embodiment of the invention and in other fields and can constitute advantageous and inherently protectable embodiments for which protection is claimed here. The subdivision of the application into individual sections and sub-headings does not restrict the general validity of the statements made thereunder.

### BRIEF DESCRIPTION OF THE SEVERAL VIEWS OF THE DRAWINGS

Exemplary embodiments of the invention are schematically illustrated in the drawings and will be explained in greater detail in the text which follows. In the drawing:

FIG. 1 shows a greatly enlarged view of a weave with warp threads which are composed of heating conductor material and with weft threads which are composed of electrically insulating fibres;

FIG. 2 shows one possible refinement of a hob having a heating device with a heating element according to the invention;

FIG. 3 shows a schematic apparatus for producing a heating element according to the invention from a weave according to FIG. 1;

FIG. 4 shows a refinement of a heating element according to the invention comprising a weave according to FIG. 1 with a corrugated structure;

FIGS. 5 and 6 show different plan views of lattice-like heating elements with wide contact strips at the sides;

FIG. 7 shows a schematically illustrated possible tensioned arrangement of a heating element according to the invention in a heating device;

FIG. 8 is a simplified illustration of an oven having heating devices according to the invention as a heating body providing heat from the bottom and a heating body providing heat from the top; and

FIG. 9 is a schematic illustration of a further oven having a heating device according to the invention together with a catalyst function on a fan for a hot-air function.

### DETAILED DESCRIPTION

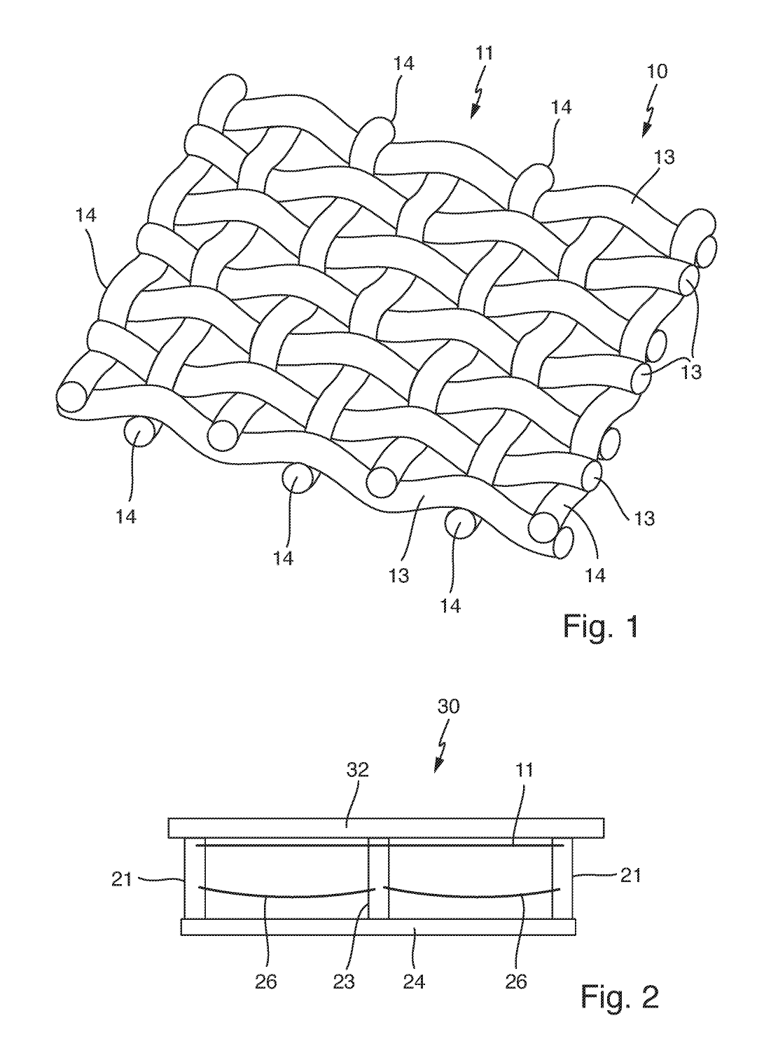

FIG. 1 illustrates a greatly enlarged view of a weave 10 which consists of warp threads and weft threads 14. Here, neither thread is designed to run in a completely rectilinear manner, this providing good structural cohesion of the weave 10. The warp threads 13 are composed of heating conductor material, for example of alloys containing nickel and chromium or containing iron, chromium and aluminium, as mentioned at the outset. The warp threads 13 are advantageously in the form of fine wires.

The weft threads 14 can, in principle, also have a heating element function, but they are advantageously electrically insulating and primarily intended to provide support and mechanical strength for the weave 10. The weft threads are composed of electrically insulating and accordingly mechanically strong and also primarily temperature-resistant material, advantageously ceramic fibres, basalt fibres, carbon fibres or aramid fibres, depending on the maximum temperature and the field of use of a heating element. In this case, the fibres are particularly advantageously multifilaments.

A thickness or a diameter of the warp threads and/or of the weft threads can be dimensioned depending on the application, for example can lie between 0.05 mm and 1 mm, advantageously between 0.1 mm and 0.5 mm.

FIG. 2 shows, by way of example, a possible refinement of a heating device 20 according to the invention having a completed heating element 11 in which a weave 10 is processed, as will be discussed further below. The sheet-like heating element 11 is arranged on a preferably rectangular holding edge which runs on the outside, advantageously clamped in or inserted into slots and held therein. The holding edge 21 can, just like a central holder 23 in the centre for the heating element 11, be composed of correspondingly temperature-resistant and highly thermally-insulating material, for example pressed vermiculite or a similar material, as is customarily used for radiant heating devices in hobs. The holding edge 21 and the central holder 23 stand on an insulating substrate 24 which is composed of the same material. Under certain circumstances, the parts can even be at least partially integrally produced with one another. A reflector 26, which can also be held by the central holder 23 and the holding edge 21, runs beneath the heating element 11. The reflector can run in a planar manner or can respectively be slightly curved by means of a sagging portion in order to possibly achieve a better reflection effect.

The heating device 20 according to the invention is installed into a hob 30 according to the invention as a heating arrangement, as is illustrated in FIG. 2. The hob 30 has a hob plate 32 beneath which or pressed against the bottom side of which the heating device 20 is arranged. As in the case of glass-ceramic hobs with radiant heating which are known per se, the heat which is generated by the heating device 20 or the heating element 11 is emitted upwards through the hob plate 32 into a pot which is positioned on the hob plate. However, this substantially corresponds to an analogous equivalent of a, for example, abovementioned radiant heating device and for this reason does not need to be explained any further.

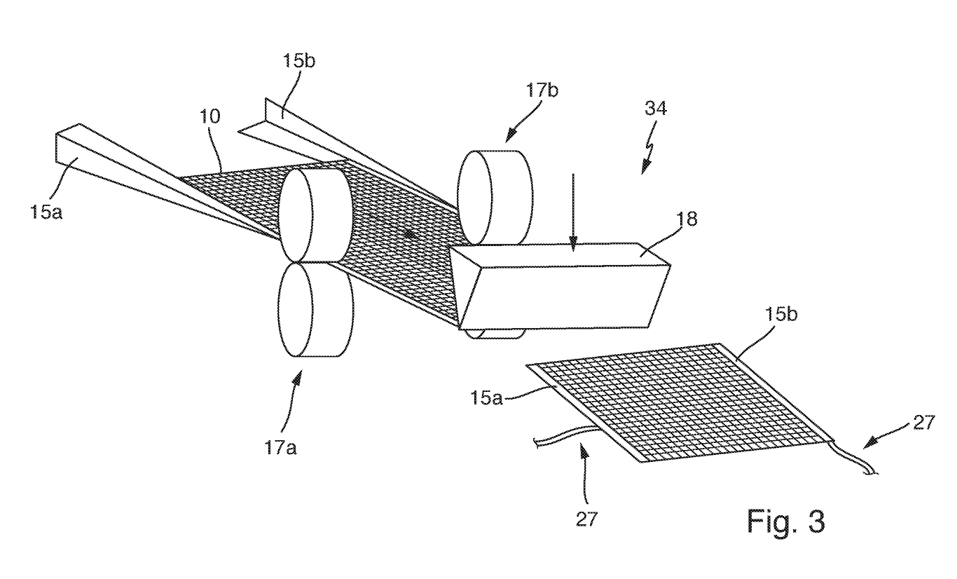

FIG. 3 shows how a completed heating element 11 according to the invention is produced from a weave 10 according to FIG. 1 in an apparatus 34. The weave 10 is cut into elongate strips and is present in this form and is inserted into the apparatus 34. In the process, the electrically insulating weft threads run in the passage direction and the warp threads with the heating element function run in a direction transverse to the passage direction. Contact strips 15a and 15b which have already been partially folded are then possibly guided to the outer sides and folded one onto the other by folding means, not illustrated, wherein the side edges of the weave 10 are folded into the folded contact strips 15a and 15b. Here, the overlap can be between 2 mm and 20 mm, advantageously 5 mm to 15 mm.

After the folding-in operation, a roll seam welding device 17a is provided on the left-hand side and a roll seam welding device 17b is provided on the right-hand side. These roll seam welding devices weld the weave 10 or the warp threads 13 which are composed of metal to the contact strips 15a and 15b, wherein, under certain circumstances, they can also take over the folding-in operation. Firstly a secure and stabilizing mechanical connection and secondly an electrical connection are established owing to the welding.

The completed desired heating elements 11 are then cut to the appropriate length by means of a cutting device 18. In this case, the warp threads with the heating element function run from one contact strip 15a to the other contact strip 15b.

The FIG. 3 further schematically illustrates how electrical connections 27 can be attached to the contact strips 15a and 15b, for example as short connection wires. To this end, they can be welded on. As an alternative, fixed contact plugs could also be attached or welded on as contact shoes or flat insertion lugs.

It is easily conceivable that the heating element 11 according to FIG. 3 has a rectangular shape, for example a square shape. The shape of a parallelogram would also be possible in principle, but practical applications for this are rather rare.

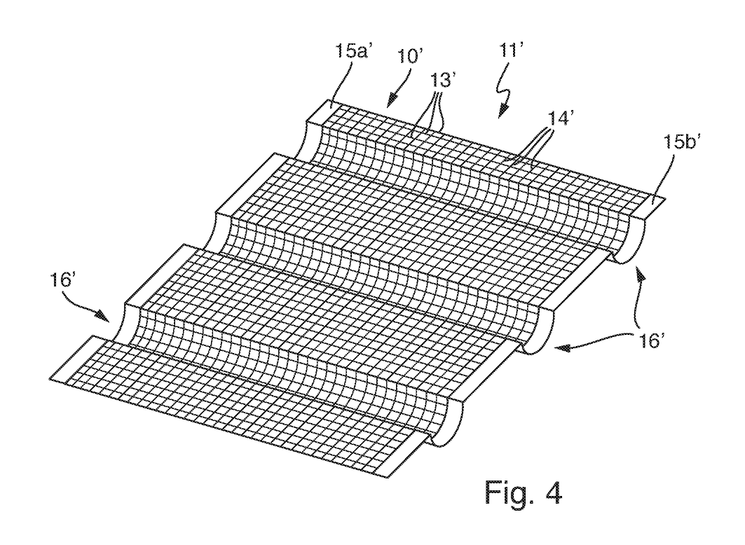

FIG. 4 shows, by way of example, a further possible refinement of a heating element 11′ according to the invention similar to that which is obtained at the end of the method according to FIG. 3. Here, a corrugated or trench-like structure is inserted into the heating element 11′ or into the weave 10′ comprising warp threads 13′ and weft threads 14′, and primarily into the lateral contact strips 15a′ and 15b′. The structure serves to stabilize the heating element 11′ overall, specifically primarily the weave 10′. Instead of the trenches which run transverse to the contact strips 15a′ and 15b′, obliquely running or longitudinally running trenches or similar structures could also be inserted, for example also crossed-over structures in the manner of a known diamond pattern. Similarly, more trenches which are arranged closer together could be provided, so that an abovementioned corrugated structure is produced. The trenches 10′ could also be modified such that they are almost pointed or bent as a kind of abovementioned sawtooth. In a yet further modification, the structures could be inserted in both directions, for example alternately.

In a yet further modification, individual relatively small regions could be impressed in a distributed manner, for example as craters or raised portions.

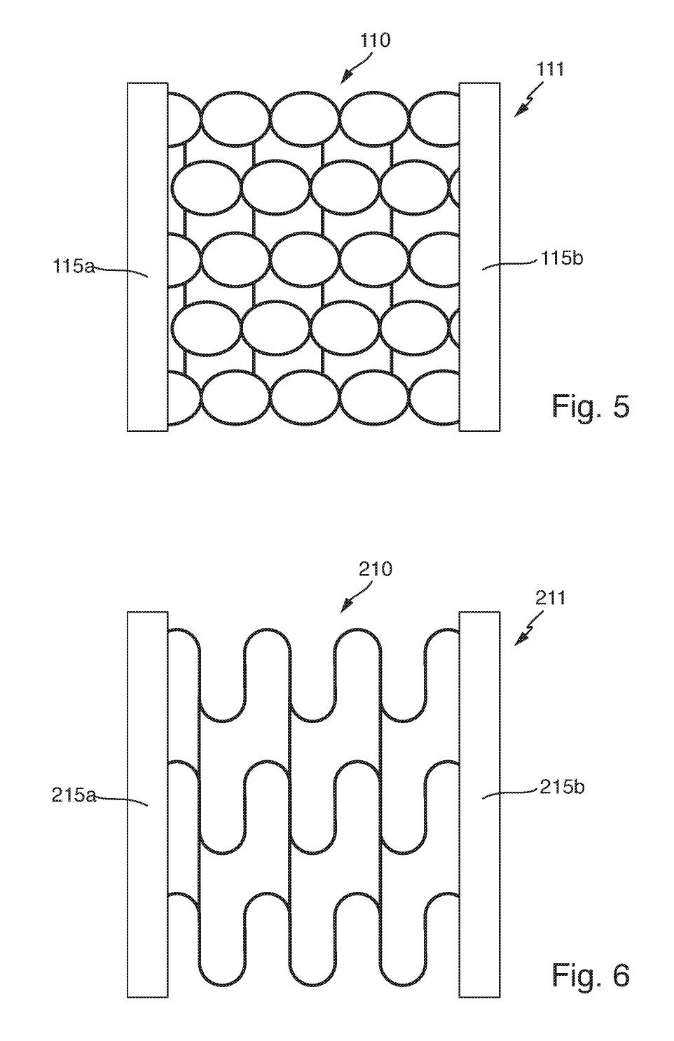

FIG. 5 illustrates a plan view of a refinement of a further heating element 111 which is in the form of a lattice or is lattice-like. A centrally arranged lattice structure 110 replaces, as it were, the weave 10 of FIGS. 1 and 3. A strip of corresponding width is folded in between two contact strips 115a and 115b, welded and therefore mechanically and electrically connected to the contact strips, just like the weave 10 as has been described above. Here, the lattice 110 has been produced by etching from a thin foil of a heating conductor material. As an alternative, it could be stamped or lasered. Current flows from one contact strip 115a to the other contact strip 115b here too. To this end, the pattern of the structure in the direction of the longitudinal direction of the contact strips 115 is advantageously regular, it being possible for this to apply particularly advantageously very generally for a heating element according to the invention.

FIG. 6 illustrates a further refinement of a heating element 211 according to the invention. This heating element is also of lattice-like design, but with a different lattice to that according to FIG. 5. Elongate heating element sections are formed in the manner of waves which are connected to one another by webs. A lattice 210 of this kind is produced advantageously in the manner described above for the lattice 110 of FIG. 5. Furthermore, this lattice 210 is also folded into two contact strips 215a and 215b in the described manner for the purpose of mechanical and electrical connection.

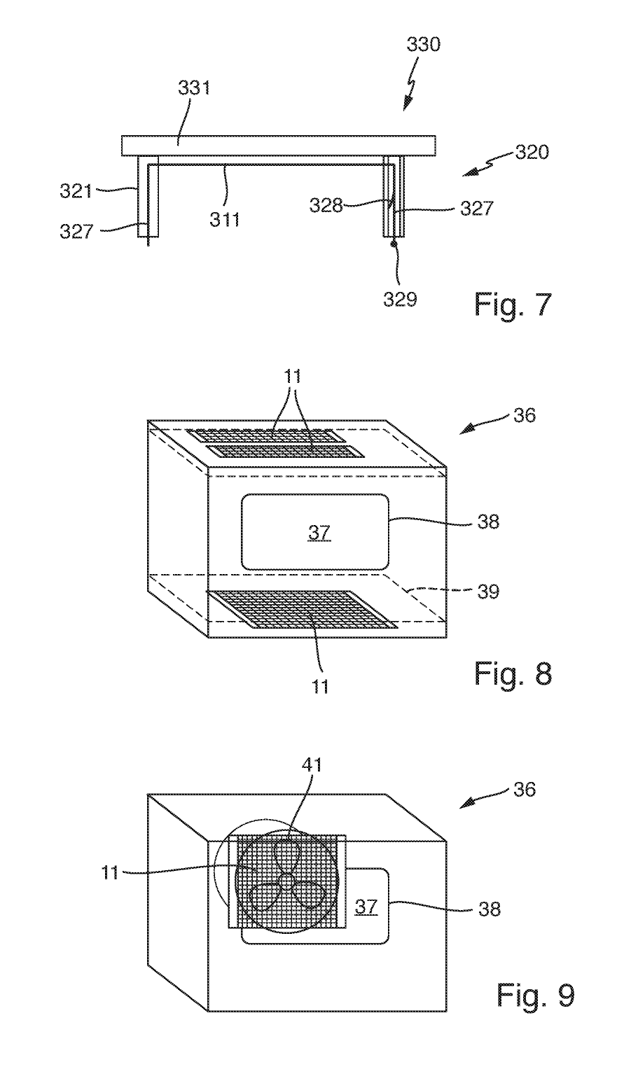

FIG. 7 shows a modification of the illustration of FIG. 2 with a heating device 320 which is permanently tensioned in a special way. In the left-hand region of a holding edge 321, an electrical connection 327 runs downwards from the left-hand edge of the heating element 311, the electrical connection also effecting fastening, possibly in addition to holding at the holding edge 321. In the right-hand region, an electrical connection 327 likewise runs downwards. However, a tensioning weight 329 is, as it were, symbolically arranged at this electrical connection, the tensioning weight pulling the right-hand-side connection 327 downwards as it were. Owing to a spring 328 which is arranged to the left of the connection 327, a certain mechanical stress is additionally generated as tension which pulls the heating element 311 smooth as far as possible. A form of the heating element 311 which is as flat and planar as possible can be achieved in this way.

FIG. 8 illustrates, as a further exemplary cooking appliance according to the invention in addition to a hob, an oven 36 with an oven muffle 37 and an oven door 38. A heating element 11 is provided, by way of example integrally, beneath the oven muffle 37 as a heating body providing heat from the bottom, specifically beneath a glass-ceramic plate 39 which, once again, is particularly transmissive to thermal radiation as in the case of the hob 30 of FIG. 2. The exact holding device for the heating element 11 is not illustrated here, but can correspond to FIG. 1 or 7 for example. It can also be seen that this lower heating element 11 can be relatively large.

The heating body providing heating from the top is provided in the upper region of the oven muffle 37 or below a muffle ceiling, by way of example by combining two narrow heating elements 11.

Both the heating body for providing heat from the top and the heating body for providing heat from the bottom can be of integral design or comprise an arrangement of rectangular heating elements which have identical or different lateral and longitudinal dimensions. Therefore, it is possible to set both the heat from the top and the heat from the bottom partially differently for the purpose of uniformly heating or browning the item being cooked, roasted or grilled.

FIG. 8 illustrates a hot-air function for the oven 36 from FIG. 8, in a separate manner merely for the purpose of better understanding. A fan 41 which is provided for this purpose is arranged in the rear region of the oven muffle 37. A heating element 11 is arranged in the air path, advantageously behind the fan for thermal reasons, the heating element heating up the air blown through or conveyed through for the hot-air function of the oven 36. In addition, the heating element 11 can be at least partially coated with a catalytically active material, advantageously completely coated, here. Therefore, a novel directly heated catalyst heating element for an oven can be provided, as a result of which, for example, the ambient air in an oven 36 of this kind can be purified for the purpose of reducing impurities and unpleasant odors.

A holding device for the heating element 11 is not illustrated in any detail here either, but is easily conceivable. For example, the two contact strips 15 on the sides are, in turn, primarily also suitable for fastening the heating element 11.

That which is claimed:

1. A heating device comprising:
a sheet-like heating element comprising an outer edge and with a holding device for said heating element, wherein:
said heating element is held along said outer edge on said holding device and, by way of at least 70% of a surface area of said heating element, runs freely between said holding device or within said holding device;
said heating element comprises a lattice or a weave; and
said lattice or said weave at least partially comprises a heating conductor material.

2. The heating device according to claim 1, wherein said heating element is held at least at holding points of said holding device.

3. The heating device according to claim 2, wherein said holding points are along a holding line.

4. The heating device according to claim 1, wherein said heating element is three-dimensionally structured for mechanical stabilization in a perpendicular direction or in a direction perpendicular and parallel to opposite outer edges of said heating element.

5. The heating device according to claim 1, wherein said heating element has a corrugated, sinusoidal or sawtooth-like structure or trench-like or crater-like stabilizing embossed portions.

6. The heating device according to claim 5, wherein said embossed portions are not directed or do not have an orientation.

7. The heating device according to claim 1, wherein a sheet-like reflector is provided in a direction away from a heating direction of said heating element.

8. The heating device according to claim 7, wherein said reflector is held on said holding device beneath said heating element.

9. The heating device according to claim 1, wherein said holding device is formed in an annularly circumferential manner and substantially bounds a lateral extent of said heating device, wherein said heating element is arranged and runs within said lateral extent of said heating device.

10. The heating device according to claim 1, wherein said heating element, as viewed from a heating direction, has a rectangular shape with two connection contact-making arrangements on opposite outer sides.

11. The heating device according to claim 1, wherein:
two opposite outer edges of said heating element comprising said lattice or said weave are connected to contact strips; and
said contact strips are composed of electrically conductive strip material.

12. The heating device according to claim 11, wherein said contact strips are mechanically and electrically connected to said heating element as a composite in a continuous process.

13. The heating device according to claim 12, wherein said contact strips are mechanically and electrically connected to said heating element by a welding process.

14. The heating device according to claim 1, wherein said lattice or said weave of said heating element comprises warp wires or warp threads and weft wires or weft threads.

15. The heating device according to claim 14, wherein only said warp wires or said warp threads are electrically conductive for said heating element function.

16. The heating device according to claim 1, wherein said heating element is in the form of a lattice with wires or threads, wherein said wires or said threads run substantially at right angles.

17. The heating device according to claim 1, wherein said heating element comprises heating element sections and intermediate areas which run between said heating element sections.

18. The heating device according to claim 17, wherein a surface area proportion of said intermediate areas is greater than a surface area proportion of said heating element sections.

19. The heating device according to claim 18, wherein a surface area proportion of said intermediate areas is greater than a surface area proportion of said heating element sections by a factor of 2 to 20.

20. The heating device according to claim 1, wherein said heating element is at least partially coated with a catalytically active material.

21. The heating device according to claim 20, wherein said electrically conductive heating element sections, are at least partially coated with said catalytically active material.

22. The heating device according to claim 17, wherein said wires or said heating element sections are directly composed of catalyst material.

23. A cooking appliance in the form of a hob, comprising a hob plate and at least one heating device according to claim 1, wherein at least one said heating device is arranged beneath said hob plate.

24. A cooking appliance in the form of an oven, comprising an oven muffle and at least one heating device according to claim 1, wherein at least one said heating device is arranged in said oven muffle.

25. The cooking appliance according to claim 24, wherein said heating device is arranged in said oven muffle as a heating body providing heat from a bottom said oven muffle.

26. The cooking appliance according to claim 24, wherein said heating device is arranged in said oven muffle as a heating body providing heat from an upper side of said oven muffle.

27. The cooking appliance according to claim 24, wherein one said heating element is provided with catalytically active material and is provided on an oven muffle.

28. The cooking appliance according to claim 27, wherein said heating element being provided with catalytically active material is provided close to a fan of a hot air oven.

29. A method for producing one said heating element for said heating device according to claim 1, comprising:
forming a strip from said lattice or said weave comprising heating element sections and a heating element function being of sheet-like design;
folding two opposite outer edges of said strip composed of said lattice or said weave into contact strips composed of electrically conductive strip material in a continuous process;
mechanically and electrically connecting said contact strips to said strip comprising said lattice or said weave as composite in a continuous process; and
cutting said composite, as heating element, to a specific length.

30. The method according to claim 29, wherein solid or braided electrical connection lines are attached to one said contact strip in each case.
